(19) United States
(12) Patent Application Publication
(10) Pub. No.: US 2013/0107555 A1
(43) Pub. Date: May 2, 2013

(54) SOLAR-POWERED TRAILER LIGHTING

(71) Applicant: Diane Quinn, Waterford, CA (US)

(72) Inventor: James D. Quinn, Waterford (CA)

(73) Assignee: Diane Quinn, Waterford, ON (CA)

(21) Appl. No.: 13/624,795

(22) Filed: Sep. 21, 2012

Related U.S. Application Data
(60) Provisional application No. 61/537,424, filed on Sep. 21, 2011.

(51) Int. Cl. F21L 4/08

(52) U.S. Cl. CPC F21L 4/08
USPC 362/485

(57) ABSTRACT

The solar-powered trailer lighting has a plurality of solar panels mounted on top and side exterior surfaces of a trailer, a plurality of LED lights within the interior of the trailer for illumination, a battery electrically coupled to the solar panel for receiving electrical power, the battery providing electrical power to the plurality of lights, a control circuit electrically coupled with the solar panel, plurality of lights and battery, the control circuit being arranged to allow the battery to be charged with electrical power from the solar panels and direct power from the battery to the plurality of lights. A motion sensor is coupled to the control circuit to detect movement within the trailer to turn the lights on, and a manually operable switch is provided to turn the lights off.

### CROSS-REFERENCE TO RELATED APPLICATION

This application claims the benefit of U.S. Provisional Patent Application Ser. No. 61/537,424, filed Sep. 21, 2011.

### BACKGROUND OF THE INVENTION

1. Field of the Invention

The present invention is directed to trailers, and more particularly to solar-powered trailer lighting adapted to illuminate the interior of a trailer and any similar type of vehicle to facilitate proper cargo handling in the interior of the trailer by providing ecologically advantageous illumination.

2. Description of the Related Art

In the trucking/shipping industry, there are substantial maintenance costs associated with maintaining shipping and receiving dock light fixtures and bulb replacements. There is also the cost of electricity associated with bay doors that use lights allowing the trailers to be illuminated so that loading and unloading of cargo can be carried out, As used herein, the term “trailers” should be taken as broad enough to encompass any vehicle or vehicle portion for transporting cargo, e.g., a semitrailer, a truck/cube van, or a closed/boxed-in vehicle. Even where sufficient and continuous funds exist for adequate lighting, replacement issues arise haphazardly, and often lighting will fail and need to be replaced at an inconvenient time, creating a gap in lighting. Regardless of the cause, inadequate lighting can cause a reduction in work efficiency, or even damage to goods being shipped from misjudging the location of goods in a poorly lit trailer. The cost of damaged goods can greatly exceed the cost of lighting.

Thus, solar-powered trailer lighting solving the aforementioned problems is desired.

### SUMMARY OF THE INVENTION

The solar-powered trailer lighting includes solar panels adapted for mounting on a trailer or the truck cab, the solar panels being used to charge a battery or batteries that are used to energize onboard lighting. The truck lighting may include a light fixture or fixtures that are secured to an interior wall, walls and/or ceiling of the trailer (as it will be referred to for the sake of simplicity hereinafter) and positioned to illuminate the interior to assist operators in making proper judgments of location and distances. The truck lighting may also include a motion sensor to detect movement of an operator when cargo is being loaded/unloaded, Further, in order to attenuate possible waste of electrical energy, a manually operable switch is provided to disable the motion detector when loading/unloading operations are not being carried out and/or illumination is not required. This prevents unnecessary waste of electrical energy due to the inadvertent detection of movement of the cargo during transit or the like.

These and other features of the present invention will become readily apparent upon further review of the following specification and drawings.

### BRIEF DESCRIPTION OF THE DRAWINGS

FIG. 1 is an environmental, perspective view of solar-powered trailer lighting according to the present invention, shown mounted on a semitrailer.

FIG. 2 is an environmental, perspective view of portions of solar-powered trailer lighting of FIG. 1, the solar panels being removed to show further details of the lighting system.

FIG. 3A is a diagrammatic, rear view of a light fixture for solar-powered trailer lighting according to the present invention, the fixture having a peaked top edge.

FIG. 3B is a diagrammatic, front view of the light fixture of FIG. 3A.

FIG. 4 is a diagrammatic side-view in section of an alternative embodiment of a light fixture for solar-powered trailer lighting according to the present invention.

FIG. 5 is a block diagram of the electrical circuitry of solar-powered trailer lighting according to the present invention.

### Similar reference characters denote corresponding features consistently throughout the attached drawings.

### DETAILED DESCRIPTION OF THE PREFERRED EMBODIMENTS

The solar-powered trailer lighting uses solar panels mounted on exterior portions of a trailer to generate electricity for efficient LED lights in the interior of the trailer. Electricity generated by the solar panels is stored in one or more batteries for later use by the LED lights when motion is detected inside the trailer corresponding to loading and unloading. A manually operable switch can deactivate the motion detector to keep the lights off, if desired.

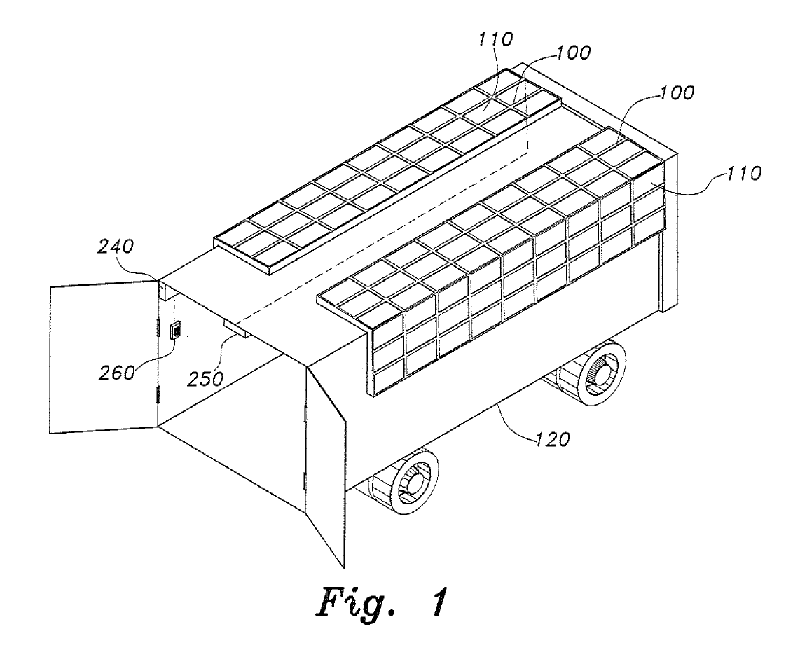

FIG. 1 shows an environmental, perspective view of solar-powered trailer lighting according to the present invention. Roof-mounted solar panels 100 and side-mounted solar panels 110 are shown mounted on the exterior of a truck trailer 120. Note that it is not necessary to have all of the roof-mounted solar panels 100 and side-mounted solar panels 110 shown in the drawing, and some may be eliminated for cost-savings. The roof-mounted solar panels 100 and side-mounted solar panels 110 can be identical, except as to where they are attached to the exterior of trailer 120. Both the roof-mounted solar panels 100 and side-mounted solar panels 110 incorporate photovoltaic solar cells to generate electricity from sunlight incident on the trailer 120. Because the trailer 120 is used to transport cargo between different locations, it is often exposed to sunlight, depending on weather conditions. The solar panels 100, 110 also further insulate and protect the trailer 120 to some degree from the external environment. Electricity generated from the solar panels is stored in at least one battery 130, as described herein.

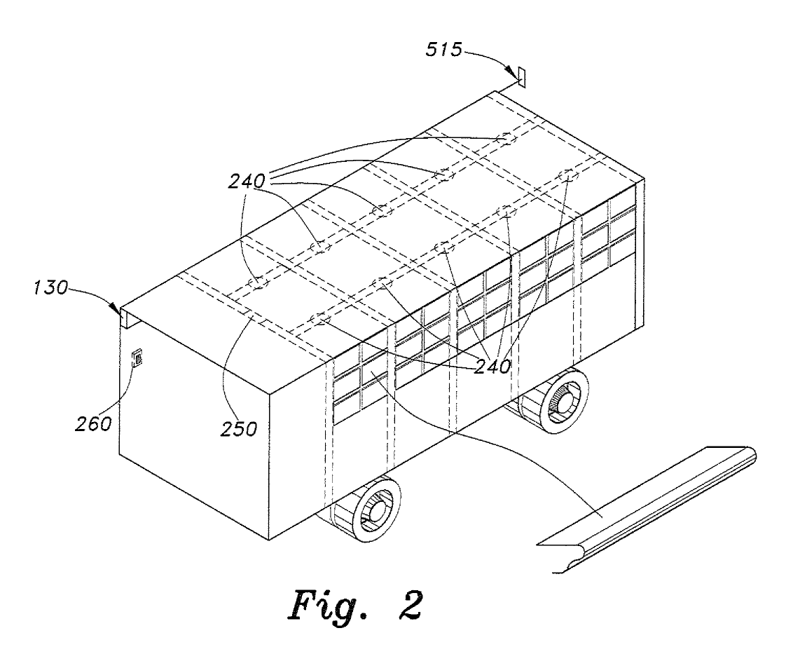

FIG. 2 shows an environmental, perspective view of portions of solar-powered trailer lighting according to the present invention. Electrical power from the solar panels 100, 110 is stored in at least one battery 130 for use in light-emitting diode (LED) 12-volt direct-current (DC) lights 240, which are shown mounted in two parallel tracks running longitudinally on the ceiling of the trailer 120. An optional, additional external battery 515 is also shown here. The LED lights 240 can also be staggered to achieve more uniform illumination. The LED lights 240 are shown as eight (8) individual LED lights, any number of lights may be used. The lights 240 preferably use LEDs for illumination, but the lights 240 can be any type of lights, including incandescent and florescent lights, but each LED light 240 preferentially has the halogen equivalent illumination of 75 watts for no more than 10 watts total power consumption in order to make useful and efficient use of the electricity generated by the solar panels 100, 110.

The LED lights 240 in the trailer 120 are activated by a motion sensor 250. The motion sensor 250 detects motion inside the trailer 120, typically during loading or unloading of cargo, and activates the LED lights 240. In this fashion, loading and unloading is performed in suitable lighting provided by the trailer 120, which is equipped with the solar-powered trailer lighting.

In some circumstances, movement in the trailer may not be loading or unloading, or local lighting may be adequate so that additional lighting is unnecessary, In that case, an off switch 260 enables a user to manually turn the LED lights 240 off. This also saves electrical energy stored in the battery 130.

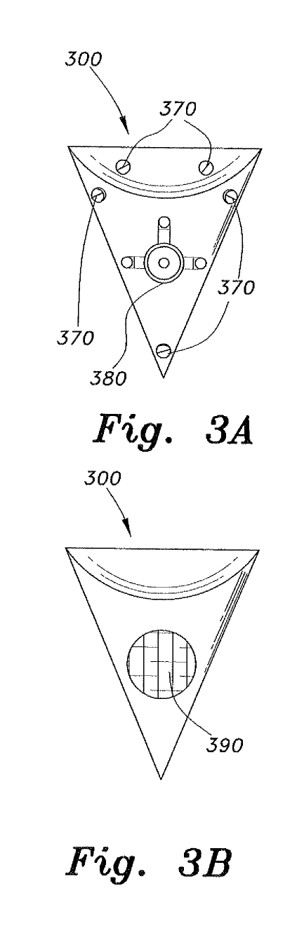

Turning to FIG. 3A, there is shown a diagrammatic, rear view of a light fixture 300 having a peaked top edge or ridge line for solar-powered trailer lighting according to the present invention. The light enclosure 300 is part of the LED lights 240, but may also be mounted in the upper, interior corners of the trailer 120 to provide additional, more uniform lighting inside the trailer 120. The light fixture 300 is shown with bolts 370 for holding the light enclosure 300 together and a light socket 380. The light fixture 300 is designed for use in both inside and outdoor applications and has a waterproof, translucent enclosure to prevent leakage into the interior of the light fixture 300. The uppermost portion of the light enclosure has a horizontally extending ridgeline or peaked edge and a rearward sloping upper portion to prevent rain from accumulating there. The upper edge and sloped surfaces also discourage snow from accumulating to a certain degree. Neoprene rubber is used internally in the light fixture 300 to form a watertight seal and further discourage water from entering the interior of the light fixture 300. The three bolts 370 nearest the light socket function to position the light socket and direct the primary axis of the flood light as desired.

FIG. 3B shows a diagrammatic front view of the light fixture of FIG. 3A. In FIG. 3B, an LED floodlight 390 is mounted in the light socket 380. The LED floodlight 390 is part of the LED lights 240 powered from electricity stored in the at least one battery 130, as described herein. The LED floodlight 390 can be movably positioned and repositioned as needed to direct light to portions of the trailer 120 where it is desired as described above. In this embodiment, the floodlight is shown behind a frosted glass window or lens. The upper portion of the enclosure slopes forward to prevent rain and snow from accumulating on the top of the fixture 300 when the fixture 300 is mounted on the outside of the trailer.

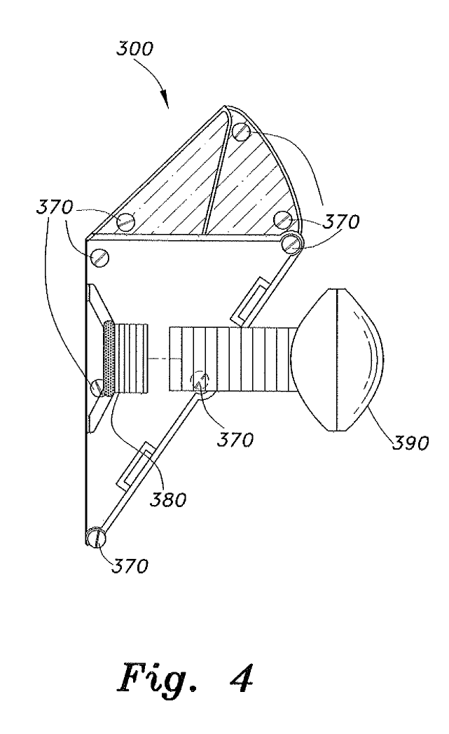

FIG. 4 shows a diagrammatic side view in section of an alternative embodiment of a light fixture for solar-powered trailer lighting according to the present invention. In FIG. 4, the LED floodlight 390 is shown positioned adjacent to the light socket 380. Unlike in FIGS. 3A and 3B, the frosted glass or lens has been removed to allow the LED floodlight 390 to extend outside of the translucent outer enclosure of the light fixture 300. The LED floodlight 390 can be brought into contact with the light socket 380 to make a physical and electrical connection to enable the LED floodlight 390 to receive electricity generated by the solar panels 100, 110 and stored in the batteries 130, 515. Note that the LED lighting 240, including the LED floodlight 390, can draw power from the solar panels 100, 110 directly if there is insufficient power stored in the batteries 130. The LED floodlight 390 extends outside of the light enclosure 300 to enable its manual repositioning and to enable the maximum amount of light to be emitted from the LED floodlight 390 without being diminished by a window, etc. Note that the light enclosure 300 contains a waterproof seal through which the LED floodlight 390 extends through into the interior of the trailer 120.

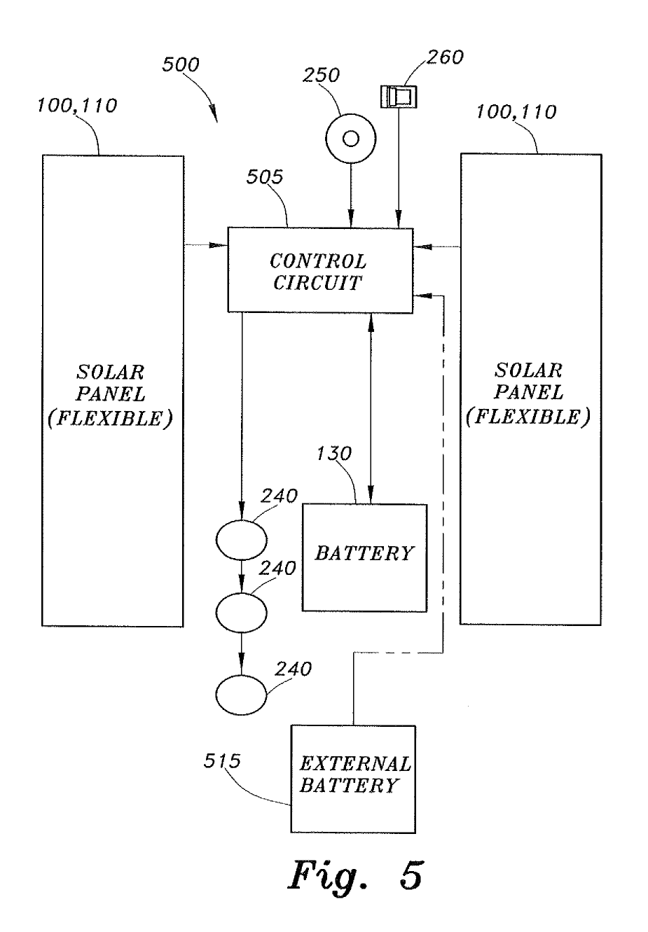

FIG. 5 shows a block diagram 500 of the electrical circuitry of solar-powered trailer lighting according to the present invention. As described herein, solar panels 100, 110 generate electricity stored in at least one battery 130. This generation and storage of electricity is regulated by a control circuit 505. The control circuit 505 ensures the battery 130 is charged and not overcharged in accordance with the amount of available electricity from the solar panels 100, 110. An additional external battery 515 can also be connected to the control circuit 505 to provide additional power or additional power storage, as desired. Electrical power is directed to the LED lights 240 under control of the control circuit 505 as triggered by the motion sensor 250. Manual activation of the off switch 260 triggers the control circuit 505 to deactivate the LED lights 240, regardless of signals received from the motion sensor 250.

The control circuit 505 can contain a microprocessor, but this is not a requirement. Information received by the motion sensor can be used to trigger a timer so that the control circuit will keep the LED lights 240 on for a certain period of time after the last motion was detected to ensure workers operating inside the trailer 120 have adequate lighting.

It is to be understood that the present invention is not limited to the embodiments described above, but encompasses any and all embodiments within the scope of the following claims.

I claim:

1. Solar-powered trailer lighting for a trailer having exterior surfaces and an interior, the solar-powered lighting comprising:
a solar panel disposed on at least one external surface of the trailer;
a plurality of lights disposed within the interior of the trailer to illuminate the interior of the trailer;
a battery electrically coupled to the solar panel for receiving electrical power from the solar panel, the battery also being connected to the lights for providing electrical power to the plurality of lights;
a control circuit electrically coupled with the solar panel, the plurality of lights, and the battery, the control circuit being configured for charging the battery with electrical power generated by the solar panels and for directing power from the battery to the plurality of lights;
a motion sensor positioned within the trailer and arranged to detect movement within the trailer, the motion sensor being connected with the control circuit and configured to direct electrical power from the battery to the plurality of lights when movement is detected by the motion sensor; and
a manually operable switch connected with the control circuit and the motion sensor to enable electrical energy to be selectively supplied fro the battery to the lights.

2. A trailer, comprising:
an enclosure having a top wall, a bottom wall, and a plurality of sidewalls extending between the top wall and the bottom wall;
a plurality of wheels, the enclosure being mounted on the plurality of wheels, the enclosure defining a trailer adapted for towing by a vehicle;
a plurality of solar panels mounted on the walls of the enclosure and positioned for exposure to sunlight;
a plurality of light fixtures mounted inside the enclosure, the light fixtures having electrical lights installed therein;
a motion detector mounted on the trailer and configured to detect motion inside the trailer;
at least one battery mounted on the trailer; and
a control circuit connected between the solar panels, the at least one battery, the light fixtures, and the motion detector for switching the lights on when motion is detected inside the enclosure and switching the lights off in the absence of motion, for charging the at least one battery with electricity generated by the solar panels, and for alternately powering the lights from the at least one battery and directly from the solar panels.
